(19) United States
(12) Patent Application Publication
(10) Pub. No.: US 2024/0335080 A1
(43) Pub. Date: Oct. 10, 2024

(54) MOBILE ROBOT

(71) Applicant: LG ELECTRONICS INC., Seoul (KR)

(72) Inventors: Suuk CHOE, Seoul (KR); Kyeongtae KIM, Seoul (KR)

(73) Assignee: LG ELECTRONICS INC., Seoul (KR)

(21) Appl. No.: 18/579,101

(22) PCT Filed: Jul. 7, 2022
(86) PCT No.: PCT/KR2022/009824

§ 371 Date: Jan. 12, 2024

(30) Foreign Application Priority Data
Jul. 14, 2021 (KR) 10-2021-0092293

(51) Int. Cl. A47L 11/40

(52) U.S. Cl. CPC A47L 11/4011; A47L 11/4008; A47L 2201/04

(57) ABSTRACT

The present invention relates to a mobile robot which, if an impact sensing signal is input, estimates a virtual wall-registerable area including a plurality of cells on the basis of the position where the impact sensing signal is input, and registers one of the plurality of cells in the virtual wall-registerable area as a virtual wall on the map according to registration priority.

### TECHNICAL FIELD

The present disclosure relates to a mobile robot that sets a virtual wall such that the mobile robot is prevented from approaching within a cleaning area.

### BACKGROUND ART

In general, a mobile robot is a device that automatically cleans an area to be cleaned by sucking dust and other foreign substances from the floor while traveling within the area without user intervention.

Such a mobile robot detects distances to obstacles such as furniture, office equipment, and walls installed in a cleaning area and maps the cleaning area accordingly, or performs an obstacle avoidance operation by controlling driving of left and right wheels.

Even if a mobile robot detects an obstacle, the mobile robot changes the path to a different path or moves after approaching the obstacle for cleaning.

However, in a case where a mobile robot approaches an obstacle and damages the obstacle, for example, if a mobile robot approaches a flowerpot or vase and thus the flowerpot or vase falls, it may be damaged. Further, it often happens that a mobile robot approaches an obstacle and falls down stairs, or climbs on a threshold or some obstacle and becomes isolated.

If a mobile robot is designed to avoid an obstacle unconditionally upon detecting the obstacle due to the aforementioned problems, the mobile robot will not be able to clean an area.

Accordingly, a method that is based on setting an operation after approaching an obstacle and makes parts of a cleaning area inaccessible has been devised.

A device that generates a predetermined signal is installed in a cleaning area to prevent a mobile robot from approaching, thereby preventing the mobile robot from accessing an area set by the device.

However, additional purchase costs are incurred since the device for generating signals needs to be purchased additionally, and since the device for generating signals needs to be installed indoors, the installation space is limited. Further, in a case where the device for generating a signal is used, a mobile robot cannot ascertain the position and size of an area set by the signal, and thus there is a problem in that the mobile robot needs to repeatedly detect the signal while moving.

This causes user inconvenience because the device acts as an obstacle when moving within a cleaning area. Additionally, since the device needs to be installed in each required area, it is necessary to move and install the device every time cleaning is performed, which is inconvenient.

In addition, as in prior art literature, technology in which a user directly set a position of a virtual wall through a terminal is also being studied. However, in the case of this prior art, there is a problem in that a user needs to manually set a virtual wall. In particular, for a user who is not familiar with using a terminal, it is very difficult to set a position of a virtual wall on a map, and when the user sets the position, there is a high risk of errors in setting the position of the virtual wall.

### PRIOR ART LITERATURE

### Patent Literature

Korean Patent Publication No. 20180085309

### DISCLOSURE

### Technical Problem

An object of the present disclosure is to provide a mobile robot that sets a virtual wall such that the mobile robot is prevented from approaching within a cleaning area to restrict movement of the mobile robot.

An object of the present disclosure is to provide a mobile robot that automatically sets a virtual wall through sensing and various algorithms without a user.

An object of the present disclosure is to provide a mobile robot that sets the most reasonable virtual wall registration order in consideration of bumper conditions and sensing conditions based on a grid map to prevent unexpected bumping in future traveling.

An object of the present disclosure is to provide a mobile robot that rapidly responds to continuously changing cleaning environments and has improved cleaning performance and traveling performance by updating virtual wall information on a map temporally and spatially.

The objects of the present disclosure are not limited to the objects mentioned above, and other objects not mentioned will be clearly understood by those skilled in the art from the description below.

### Technical Solution

In accordance with the present disclosure, the above and other objects can be accomplished by the provision of a mobile robot including an obstacle determination unit configured to determine whether an external object that has collided with a main body is an obstacle on the basis of an obstacle detection signal when an impact detection signal is input, an area calculation unit configured to determine a virtual wall registerable area including a plurality of cells on the basis of the position on a map where the impact detection signal is input when the obstacle determination unit determines that the external object that has collided with the main body is not an obstacle, and a virtual wall registration unit configured to register one of the plurality of cells within the virtual wall registerable area as a virtual wall on the map according to registration priority.

A mobile robot according to another embodiment of the present disclosure determines a virtual wall registerable area including a plurality of cells on the basis of a position on a map where an impact detection signal is input when the impact detection signal is input, and registers one of the plurality of cells in the virtual wall registerable area as a virtual wall on the map according to registration priority.

Specifically, a mobile robot according to an embodiment of the present disclosure includes a main body, a travel driving unit provided in the main body and configured to move the main body, a data unit in which a map of cleaning areas is stored, an impact detection sensor disposed in the main body and configured to detect impact between the main body and an external object and to generate an impact detection signal, and a control unit configured to generate the map including information on the cleaning areas, wherein the control unit includes an obstacle determination unit configured to determine whether an external object that has collided with a main body is an obstacle on the basis of the obstacle detection signal when the impact detection signal is input, an area calculation unit configured to determine a virtual wall registerable area including a plurality of cells on the basis of the position on a map where the impact detection signal is input when the obstacle determination unit determines that the external object that has collided with the main body is not an obstacle, and a virtual wall registration unit configured to register one of the plurality of cells within the virtual wall registerable area as a virtual wall on the map according to registration priority.

The area calculation unit may calculate coordinates of a signal input cell on the map corresponding to the position where the impact detection signal is input and determine the signal input cell and at least one neighboring cell adjacent to the signal input cell as the virtual wall registerable area.

The area calculation unit may calculate coordinates of a signal input cell on the map corresponding to the position where the impact detection signal is input and determine the signal input cell and at least one neighboring cell adjacent to the signal input cell as the virtual wall registerable area in consideration of a size of the main body, a shape of the main body, and an installation position of the impact detection sensor.

The virtual wall registration unit may determine a first priority cell from among the plurality of cells within the virtual wall registerable area according to the registration priority and register the first priority cell as a virtual wall in the map according to attributes of the first priority cell.

The virtual wall registration unit may determine a first priority cell from among the plurality of cells within the virtual wall registerable area according to the registration priority and register the first priority cell as a virtual wall if attributes of the first priority cell in the map do not indicate a virtual wall.

The virtual wall registration unit may determine a second priority cell from among the plurality of cells within the virtual wall registerable area according to the registration priority if the attributes of the first priority cell indicate a virtual wall, and register the second priority cell as a virtual wall according to attributes of the second priority cell.

The virtual wall registration unit may determine an n-th priority cell from among the plurality of cells within the virtual wall registerable area according to the registration priority, register the n-th priority cell as a virtual wall according to attributes of the n-th priority cell in the map, determine an (n+1)-th priority cell from among the plurality of cells within the virtual wall registerable area according to the registration priority if the n-th priority cell is not able to be registered as a virtual wall according to the attributes of the n-th priority cell, and register the (n+1)-th priority cell as a virtual wall according to attributes of the (n+1)-th priority cell in the map.

The virtual wall registration unit may determine the registration priority in descending order of a probability of not detecting impact in areas depending on a position at which the impact detection sensor is disposed.

The impact detection sensor may include a first impact detection sensor located on the side of the main body between a front end of the main body and a left end of the main body, and a second impact detection sensor located on the side of the main body between the front end of the main body and a right end of the main body.

If impact detection signals are simultaneously input from the first impact detection sensor and the second impact detection sensor, the area calculation unit may calculate coordinates of a first signal input cell and a second signal input cell on the map corresponding to positions of the first impact detection sensor and the second impact detection sensor, and determine cells between the first signal input cell and the second signal input cell, the first signal input cell, and the second signal input cell as the virtual wall registerable area.

The virtual wall registration unit may set a higher registration priority to a cell farther from a center between the first impact detection sensor and the second impact detection sensor among the cells between the first signal input cell and the second signal input cell.

If an impact detection signal is input from one of the first impact detection sensor and the second impact detection sensor, the area calculation unit may calculate coordinates of a signal input cell on the map corresponding to a position at which the impact detection signal is input, and determine the signal input cell and at least one neighboring cell adjacent to the signal input cell as the virtual wall registerable area in consideration of the size of the main body, the shape of the main body, and the installation position of the impact detection sensor.

The virtual wall registration unit may set a higher registration priority to a cell farther from the center between the first impact detection sensor and the second impact detection sensor among the cells in the virtual wall registerable area.

The control unit may control the travel driving unit to travel while avoiding a virtual wall registered in the map.

The virtual wall registration unit may register attribute information including time information or information on the number of times of cleaning at the time of registering a virtual wall in the map.

The control unit may initialize virtual walls for which a certain period of time has elapsed among virtual walls registered in the map.

The control unit may initialize virtual walls for which a certain number of times of cleaning has passed among the virtual walls registered in the map.

The control unit may divide the map into a plurality of cleaning areas and, at the time of starting cleaning, initialize a virtual wall located within at least one cleaning area randomly selected from among the plurality of cleaning areas.

The control unit may divide the map into a plurality of cleaning areas at the start of cleaning, and initialize a virtual wall within a cleaning area determined according to the number of times of cleaning when starting cleaning.

Furthermore, a method of controlling a mobile robot of the present disclosure includes detecting an impact detection signal while a main body is traveling, if the impact detection signal is detected while the main body is traveling, determining a virtual wall registerable area including a plurality of cells on the basis of a position on a map at which the impact detection signal is input, and registering one of the plurality of cells within the virtual wall registerable area as a virtual wall in a map according to registration priority.

Specific details of other embodiments are included in the detailed description and drawings.

### Advantageous Effects

According to the mobile robot of the present disclosure, one or more of the following effects are achieved.

The present disclosure has the advantages of enabling rapid cleaning, increasing the traveling time of a mobile robot, and reducing damage to the mobile robot by setting a virtual wall such that the mobile robot cannot approaching within a cleaning area and is restricted from accessing dangerous areas and areas that do not require cleaning.

In addition, the present disclosure has the advantages of reducing the burden of setting a virtual wall on the user and preventing cleaning performance deterioration due to errors when the user sets a virtual wall because the virtual wall is automatically set by the mobile robot through sensing and various algorithms without a user.

Furthermore, the present disclosure has the advantages of enabling smart cleaning as a cleaning area is cleaned and not placing the burden of setting a virtual wall on the user because the most reasonable virtual wall registration order is set in consideration of bumper conditions and sensing conditions based on a grid map in order to prevent bumping in future traveling in case of unexpected bumping.

In addition, the present disclosure has the advantages of rapidly responding to continuously changing cleaning environments and improving cleaning performance and driving performance by initializing old virtual wall information, removing the old virtual wall information, and resetting a virtual wall while updating virtual wall information on a map temporally and spatially.

The effects of the present disclosure are not limited to the effects mentioned above, and other effects not mentioned will be clearly understood by those skilled in the art from the description of the claims.

### DESCRIPTION OF DRAWINGS

FIG. 1 is a perspective view of a mobile robot according to an embodiment of the present disclosure.

FIG. 2 is a diagram showing a horizontal angle of view of the mobile robot of FIG. 1.

FIG. 3 is a front view of the mobile robot of FIG. 1.

FIG. 4 is a diagram showing the bottom of the mobile robot of FIG. 1.

FIG. 5 is a block diagram showing main parts of the mobile robot according to an embodiment of the present disclosure.

FIG. 6 is a diagram referenced to describe a virtual map setting method of the mobile robot according to an embodiment of the present disclosure.

FIGS. 7 and 8 are diagrams referenced to describe a map generation method of the mobile robot according to an embodiment of the present disclosure.

FIG. 9 is a flowchart showing a method of controlling the mobile robot according to an embodiment of the present disclosure.

FIG. 10 is a flowchart showing a method of controlling the mobile robot according to another embodiment of the present disclosure.

### BEST MODE

The advantages and features of the present disclosure and the way of attaining the same will become apparent with reference to embodiments described below in detail in conjunction with the accompanying drawings. The present disclosure, however, is not limited to the embodiments disclosed hereinafter and may be embodied in many different forms. Rather, these exemplary embodiments are provided so that this disclosure will be through and complete and will fully convey the scope to those skilled in the art. Thus, the scope of the present disclosure should be defined by the claims. The same or extremely similar elements are designated by the same reference numerals throughout the specification.

Spatially relative terms such as “below”, “beneath”, “lower”, “above” and “upper” can be used to easily describe the correlation between a component and other components as shown in the figures. Spatially relative terms should be understood as terms that include different directions of components during use or operation in addition to directions shown in the figures. For example, if a component shown in a figure is turned upside down, a component described as “below” or “beneath” another component may be placed “above” the other component. Accordingly, the illustrative term “below” may include both downward and upward directions. Components can also be oriented in different directions, and thus spatially relative terms can be interpreted according to orientation.

The terms used herein are for describing embodiments and are not intended to limit the present disclosure. As used herein, singular forms also include plural forms, unless specifically stated otherwise in the context. As used herein, “comprise” and/or “comprising” means that a referenced component, step and/or operation do not exclude the presence or addition of one or more other components, steps and/or operations.

Unless otherwise defined, all terms (including technical and scientific terms) used in this specification may be used with meanings that can be commonly understood by those skilled in the art to which the present disclosure pertains. Additionally, terms defined in commonly used dictionaries are not to be interpreted ideally or excessively unless clearly specifically defined.

In the drawings, the thickness or size of each component is exaggerated, omitted, or schematically illustrated for convenience and clarity of explanation. Additionally, the size and area of each component do not entirely reflect the actual size or area thereof.

Hereinafter, preferred embodiments of the present disclosure will be described with reference to the accompanying drawings.

Hereinafter, the present disclosure will be described with reference to the drawings for explaining a mobile robot according to embodiments of the present disclosure.

The suffixes “module” and “part” for components used in the following description are given or used interchangeably only considering the ease of writing the specification, and do not have distinct meanings or roles in themselves.

Here, it will be understood that each block of processing flowcharts and combinations of the flowcharts can be performed by computer program instructions. Since these computer program instructions can be stored in a processor of a general-purpose computer, a special-purpose computer, or other programmable data processing equipment, the instructions executed through the processor of the computer or other programmable data processing equipment generate means for performing functions described in flowchart block(s). These computer program instructions may also be stored in a computer-usable or computer-readable memory that can be directed to a computer or other programmable data processing equipment to implement functions in a particular manner, and thus it is also possible to produce manufactured items containing instruction means that perform the functions described in the flowchart block(s). Since computer program instructions can also be installed in a computer or other programmable data processing equipment, a series of operational steps may be performed on the computer or other programmable data processing equipment to create a process that is executed by the computer such that instructions installed in the computer or other programmable data processing equipment can also provide steps for executing the functions described in the flowchart block(s).

Additionally, each block may represent a module, segment, or portion of code that includes one or more executable instructions for executing specified logical function(s). Additionally, it should be noted that, in some alternative execution examples, it is possible for functions mentioned in blocks to occur out of order. For example, it is possible for two blocks shown in succession to be performed substantially at the same time, or it is possible for the blocks to be performed in reverse order depending on the corresponding function.

Meanwhile, in order to facilitate description of the present disclosure, the basic concept related to the present disclosure will be defined.

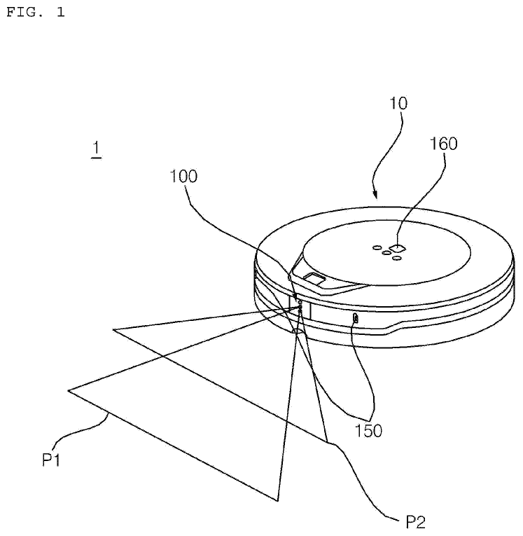

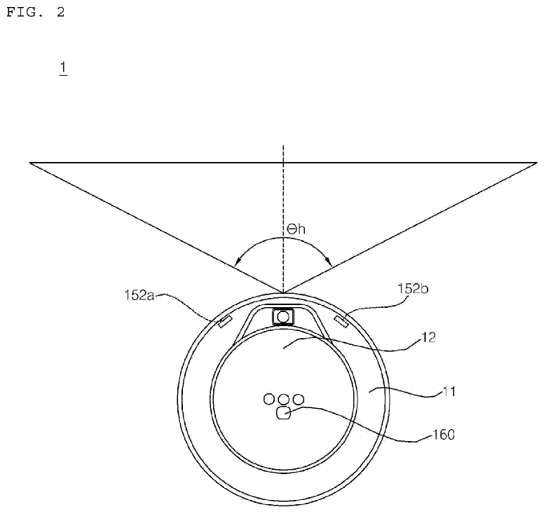

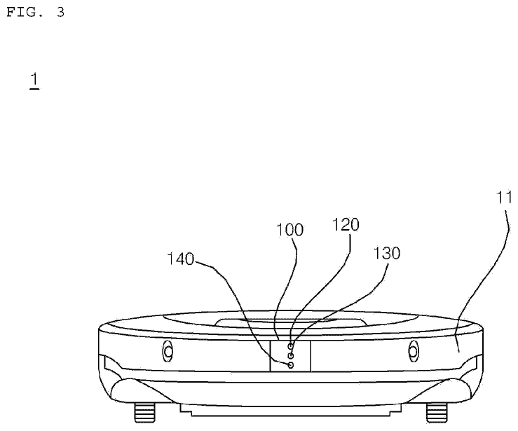

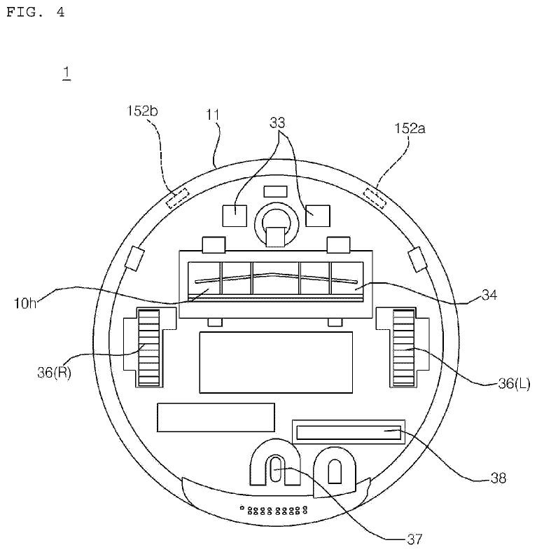

FIG. 1 is a perspective view of a mobile robot according to an embodiment of the present disclosure. FIG. 2 shows a horizontal angle of view of the mobile robot of FIG. 1. FIG. 3 is a front view of the mobile robot of FIG. 1. FIG. 4 shows the bottom of the mobile robot of FIG. 1.

Referring to FIGS. 1 to 4, the mobile robot 1 according to an embodiment of the present disclosure includes a main body 10 that moves along the floor of a cleaning area and sucks foreign substances such as dust on the floor, an obstacle detection unit 100 disposed on the front of the main body 10, and an impact detection sensor disposed on the main body 10 to detect external impact.

The main body 10 may include a casing 11 that forms the exterior and forms a space in which the parts constituting the main body 10 are stored, a suction unit 34 disposed in the casing 11 to suck in foreign substances such as dust and trash, and a left wheel 36(L) and a right wheel 36(R) rotatably provided in the casing 11. As the left wheel 36(L) and right wheel 36(R) rotate, the main body 10 moves along the floor of the cleaning area, and in this process, foreign substances are sucked in through the suction unit 34.

The suction unit 34 may include a suction fan (not shown) that generates suction force, and an inlet port 10h through which airflow generated by rotation of the suction fan is sucked. The suction unit 34 may include a filter (not shown) that collects foreign substances from the airflow sucked through the inlet port 10h, and a foreign substance collection bin (not shown) in which the foreign substances collected by the filter accumulate.

Additionally, the main body 10 may include a travel driving unit that drives the left wheel 36(L) and the right wheel 36(R). The travel driving unit may include at least one driving motor. The at least one driving motor may include a left wheel driving motor that rotates the left wheel 36(L) and a right wheel driving motor that rotates the right wheel 36(R).

As another example, the travel driving unit includes two mops that rotate around a rotation axis that intersects the floor, and the main body may be moved by friction with the floor generated by rotation of the two mops.

The operations of the left wheel driving motor and the right wheel driving motor are independently controlled by a travel control unit of a control unit such that the main body 10 can move forward, backward, or turn.

For example, when the main body 10 travels straight, the left wheel driving motor and the right wheel driving motor rotate in the same direction, but when the left wheel driving motor and the right wheel driving motor rotate at different speeds or in opposite directions, the traveling direction of the main body 10 may be changed. At least one auxiliary wheel 37 may be further provided to stably support the main body 10.

Although not shown, a plurality of brushes (not shown) composed of a plurality of radially extending blades may be further provided and located on the front side of the bottom of the casing 11. Dust is removed from the floor of the cleaning area according to rotation of the plurality of brushes, and the dust separated from the floor is sucked in through the inlet port 10h and collected in the collection bin.

A control panel including an operation unit 160 that receives various commands for controlling the mobile robot 1 from a user may be provided on the upper surface of the casing 11.

The obstacle detection unit 100 may be disposed on the front side of the main body 10.

The obstacle detection unit 100 is fixed to the front side of the casing 11 and includes a first pattern radiation unit 120, a second pattern radiation unit 130, and an image acquisition unit 140. Here, the image acquisition unit is basically provided below the pattern radiation units as shown, but in some cases, the image acquisition unit may be disposed between the first and second pattern radiation units. Additionally, a second image acquisition unit (not shown) may be further provided at the upper part of the main body. The second image acquisition unit captures an image of the area above the main body, that is, the ceiling.

As another example, the obstacle detection unit 100 may include a sensor unit 150 which will be described later.

The main body 10 is equipped with a rechargeable battery 38, and a charging terminal 33 of the battery 38 may be connected to a commercial power source (for example, a power outlet in the home) or the main body 10 may dock with a separate charging station (not shown) connected to the commercial power source such that the charging terminal 33 can be electrically connected to the commercial power source, thereby charging the battery 38. The electrical components constituting the mobile robot 1 can receive power from the battery 38, and therefore, the mobile robot 1 can travel by itself with the battery 38 charged in a state in which the mobile robot 1 is electrically separated from the commercial power source.

The impact detection sensor 152 is disposed in the main body 10 to detect an impact between the main body 10 and an external object, generates an impact detection signal, and provides the impact detection signal to the control unit 200.

In the case of the impact detection sensor 152, the manufacturing cost increases if a large number of impact detection sensors is installed, and thus it is desirable to install two impact detection sensors in order to improve sensing performance and sense unexpected bumping as much as possible.

For example, since the impact sensor 152 detects impact with an object in front of the main body 10, it can be provided at the front end of the main body 10. Additionally, the impact detection sensor 152 may be disposed between the front end and the left end of the main body 10 and between the front end and the right end of the main body 10 in order to detect front and side impacts.

Specifically, the impact detection sensor 152 may include a first impact detection sensor 152a located on the side of the main body 10 between the front end of the main body 10 and the left end of the main body 10, and a second impact detection sensor 152b located on the side of the main body 10 between the front end and the right end of the main body 10.

Referring to FIG. 2, the first impact sensor 152a may be disposed at an azimuth between 40 and 50 degrees counterclockwise from a front reference point, and the second impact sensor 152b may be disposed at an azimuth between 40 and 50 degrees clockwise from the front reference point.

Here, the front reference point can be defined as a point at which a center vertical line LC at right angles to a center horizontal line LH parallel to the rotation axis of the left wheel 36 (L) or the right wheel 36(R) meets the front end of the main body 10 at the center C of the main body 10.

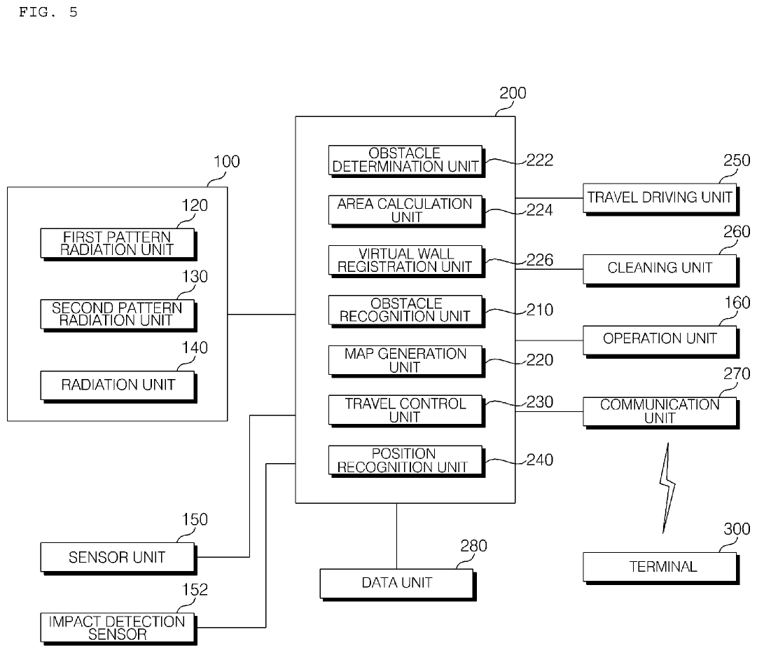

FIG. 5 is a block diagram showing main parts of the mobile robot according to an embodiment of the present disclosure.

As shown in FIG. 5, the mobile robot 1 includes a travel driving unit 250, a cleaning unit 260, a data unit 280, the obstacle detection unit 100, the sensor unit 150, the impact detection sensor 152, and the control unit 200 that controls the overall operation.

The operation unit 160 includes input means such as at least one button, switch, and touch pad and receives user commands. The operation unit may be provided on the upper part of the main body 10 as described above.

The data unit 280 stores an obstacle detection signal input from the obstacle detection unit 100 or the sensor unit 150, reference data for an obstacle recognition unit 210 to determine an obstacle, and obstacle information on a detected obstacle.

The data unit 280 stores an impact detection signal input from the impact detection sensor 152, reference data for the control unit 200 to determine an impact detection signal, and virtual wall registration information for registering a virtual wall on the basis of an impact detection signal, and information on a registered virtual wall.

Additionally, the data unit 280 stores control data for controlling the operation of the mobile robot and data according to a cleaning mode of the mobile robot, and a map including obstacle information generated by a map generation unit. The data unit 280 may store a basic map, a cleaning map, a user map, and a guide map. The obstacle detection signal includes ultrasonic/laser detection signals detected by the sensor unit and images acquired by the image acquisition unit.

In addition, the data unit 280 stores data that can be read by a microprocessor and may include a hard disk drive (HDD), a solid state drive (SSD), a silicon disk drive (SDD), a ROM, a RAM, a CD-ROM, a magnetic tape, a floppy disk, and an optical data storage device.

A communication unit 270 communicates with a terminal (not shown) through wireless communication. Additionally, the communication unit 270 may be connected to the Internet through a home network and communicate with an external server or a terminal that controls the mobile robot.

The communication unit 270 transmits a generated map to a terminal, receives a cleaning command from the terminal, and transmits data regarding the operation status and cleaning status of the mobile robot to the terminal. The communication unit 270 includes communication modules such as Wi-Fi and WiBro as well as short-range wireless communication such as ZigBee and Bluetooth and transmits and receives data.

Meanwhile, a terminal is a device equipped with a communication module, capable of accessing networks, and having a program for controlling the mobile robot or an application for controlling the mobile robot installed therein, and devices such as a computer, a laptop computer, a smartphone, a PDA, and a tablet computer can be used as terminals. Additionally, a wearable device such as a smart watch can also be used as a terminal.

The travel driving unit 250 includes at least one driving motor and causes the mobile robot to travel according to control commands from the travel control unit 230. As described above, the travel driving unit 250 may include the left wheel driving motor that rotates the left wheel 36(L) and the right wheel driving motor that rotates the right wheel 36(R).

The cleaning unit 260 operates the brushes to make it easy to suction dust or foreign substances around the mobile robot and operates a suction device to suction the dust or foreign substances. The cleaning unit 260 controls the operation of the suction fan provided in the suction unit 34 which sucks in foreign substances such as dust or trash such that dust is put into the foreign substance collection bin through the inlet port.

The obstacle detection unit 100 includes the first pattern radiation unit 120, the second pattern radiation unit 130, and the image acquisition unit 140.

The sensor unit 150 includes a plurality of sensors to assist in detecting obstacles. The sensor unit 150 detects obstacles in front of the main body 10, that is, in the traveling direction, using at least one of laser, ultrasonic waves, or infrared rays. When a transmitted signal is reflected and input, the sensor unit 150 inputs information on presence of an obstacle or the distance to the obstacle to the control unit 200 as an obstacle detection signal.

Additionally, the sensor unit 150 includes at least one tilt sensor to detect the tilting of the main body 10. When the main body 10 is tilted forward, backward, left, or right, the tilt sensor calculates the tilting direction and angle. A tilt sensor, an acceleration sensor or the like can be used as the tilt sensor, and in the case of the acceleration sensor, any of a gyro type, an inertial type, and a silicon semiconductor type sensors can be applied.

As described above, the first pattern radiation unit 120, the second pattern radiation unit 130, and the image acquisition unit 140 of the obstacle detection unit 100 are provided on the front side of the main body 10, radiate light in first and second patterns P1 and P2 to the front of the mobile robot, and obtain an image by capturing the radiated light in the patterns.

The obstacle detection unit 100 inputs the obtained image as an obstacle detection signal to the control unit 200.

The first and second pattern radiation units 120 and 130 of the obstacle detection unit 100 may include a light source and an optical pattern projection element (OPPE) that generates a predetermined pattern by transmitting light emitted from the light source. The light source may be a laser diode (LD), a light emitting diode (LED), or the like. Laser light is superior to other forms of light in terms of monochromaticity, straightness, and connection characteristics, enabling precise distance measurement. In particular, since infrared or visible light has a problem of significant differences in the precision of distance measurement depending on factors such as the color and material of an object, a laser diode is preferable as a light source. The OPPE may include a lens and a diffractive optical element (DOE). Light of various patterns may be radiated depending on the configuration of the OPPE provided in each of the pattern radiation units 120 and 130.

The first pattern radiation unit 120 may radiate light of the first pattern (P1, hereinafter referred to as first pattern light) toward the front lower side of the main body 10. Accordingly, the first pattern light P1 may be incident on the floor of the cleaning area.

The first pattern light P1 may be configured in the form of a horizontal line Ph. Additionally, the first pattern light P1 may be configured in the form of a cross pattern where a horizontal line Ph and a vertical line Pv intersect.

The first pattern radiation unit 120, the second pattern radiation unit 130, and the image acquisition unit 140 may be arranged vertically and in a line. The image acquisition unit 140 is disposed below the first pattern radiation unit 120 and the second pattern radiation unit 130, but is not necessarily limited thereto, and may be disposed above the first pattern radiation unit and the second pattern radiation unit.

In an embodiment, the first pattern radiation unit 120 may be located on the upper side and may radiate the first pattern light P1 downward toward the front to detect an obstacle located below the first pattern radiation unit 120, and the second pattern radiation unit 130 may be located below the first pattern radiation unit 120 and may radiate light of a second pattern (P2, hereinafter referred to as second pattern light) upward toward the front. Accordingly, the second pattern light P2 may be incident on an obstacle or a certain portion of the obstacle located at least higher than the second pattern radiation unit 130 from the wall or the floor of the cleaning area.

The second pattern light P2 may have a different pattern from the first pattern light P1, and preferably includes a horizontal line. Here, the horizontal line does not necessarily have to be a continuous line segment, and may be formed as a dotted line.

Meanwhile, in FIG. 2 described above, the shown radiation angle θh indicates the horizontal radiation angle of the first pattern light P1 emitted from the first pattern radiation unit 120, represents the angle formed by both ends of the horizontal line Ph and the first pattern radiation unit 120, and is preferably set to an angle in the range of 130° to 140°, but is not necessarily limited thereto. The dotted line shown in FIG. 2 points toward the front of the mobile robot 1, and the first pattern light P1 may be configured to be symmetrical with respect to the dotted line.

Like the first pattern radiation unit 120, the second pattern radiation unit 130 may also have a horizontal radiation angle, preferably set in the range of 130° to 140°, and may radiate the pattern light P2 at the same horizontal radiation angle as that of the first pattern radiation unit 120 depending on an embodiment. In this case, the second pattern light P2 may also be configured to be symmetrical with respect to the dotted line shown in FIG. 2.

The image acquisition unit 140 may acquire a front view image of the main body 10. In particular, pattern lights P1 and P2 appear in the image acquired by the image acquisition unit 140 (hereinafter referred to as acquired image). Hereinafter, images of the pattern lights P1 and P2 appearing in the acquired image are referred to as light patterns, and since they are actually images formed on an image sensor by the pattern lights P1 and P2 incident on the real space, images corresponding to the first pattern light P1 and the second pattern light P2 are referred to as a first light pattern P1 and a second light pattern P2 by assigning the same reference numerals as the pattern lights P1 and P2 thereto.

The image acquisition unit 140 may include a digital camera that converts an image of a subject into an electrical signal, converts the electrical signal into a digital signal, and stores the digital signal in a memory device, and the digital camera may include an image sensor (not shown) and an image processor (not shown).

An image sensor is a device that converts an optical image into an electrical signal and is configured as a chip in which a plurality of photodiodes is integrated, and an example of a photodiode is a pixel. Charges are accumulated in each pixel by an image formed on the chip according to light passing through a lens, and charges accumulated in pixels are converted into electrical signals (for example, a voltage). A charge coupled device (CCD), a complementary metal oxide semiconductor (CMOS), and the like are well known as image sensors.

The image processor generates digital images based on analog signals output from the image sensor. The image processor may include an AD converter that converts an analog signal into a digital signal, a buffer memory that temporarily records digital data according to a digital signal output from the AD converter, and a digital signal processor (DSP) that processes information recorded in the buffer memory to construct a digital image.

The control unit 200 includes the obstacle recognition unit 210, a map creation unit 220, the travel control unit 230, and a position recognition unit 240.

The obstacle recognition unit 210 determines an obstacle through an acquired image input from the obstacle detection unit 100, and the travel control unit 230 controls the travel driving unit 250 such that the travel driving unit 250 changes a moving direction or a traveling path in response to obstacle information to travel while passing or avoiding an obstacle.

The travel control unit 230 controls the travel driving unit 250 to independently control the operations of the left wheel driving motor and the right wheel driving motor such that the main body 10 travels straight or rotates.

The obstacle recognition unit 210 stores the obstacle detection signal input from the sensor unit 150 or the obstacle detection unit 100 in the data unit 280 and analyzes the obstacle detection signal to determine an obstacle.

The obstacle recognition unit 210 determines presence or absence of a front obstacle on the basis of the signal from the sensor unit and analyzes the acquired image to determine the position, size, and shape of the obstacle.

The obstacle recognition unit 210 analyzes the acquired image to extract a pattern. The obstacle recognition unit 210 extracts a light pattern that appears when pattern light emitted from the first pattern radiation unit or the second pattern radiation unit is radiated to the floor or an obstacle and determines the obstacle on the basis of the extracted light pattern.

The obstacle recognition unit 210 detects light patterns P1 and P2 from the image (acquired image) acquired by the image acquisition unit 140. The obstacle recognition unit 210 may detect features such as points, lines, and surfaces from predetermined pixels constituting the acquired image, and detect light patterns P1 and P2 or points, lines, surfaces, and the like that constitute the light patterns P1 and P2 on the basis of the detected features. The obstacle recognition unit 210 may extract line segments formed by successive pixels brighter than the surroundings, and extract a horizontal line Ph constituting the first light pattern P1 and a horizontal line constituting the second light pattern P2. However, the present disclosure is not limited thereto, and various techniques for extracting a pattern of a desired form from a digital image are already known, and thus the obstacle recognition unit 210 can extract the first light pattern P1 and the second light pattern P2 using these known techniques.

Additionally, the obstacle recognition unit 210 determines presence or absence of an obstacle on the basis of a detected pattern and determines the shape of the obstacle. The obstacle recognition unit 210 may determine an obstacle through the first light pattern and the second light pattern and calculate the distance to the obstacle. Additionally, the obstacle recognition unit 210 may determine the size (height) and shape of the obstacle through the shapes of the first and second light patterns and changes in the light patterns while approaching the obstacle.

The obstacle recognition unit 210 determines an obstacle on the basis of distances between a reference position and the first and second light patterns. The obstacle recognition unit 210 may determine that a downhill slope exists if the first light pattern P1 appears at a position lower than the reference position, and may determine presence of a cliff if the first light pattern P1 disappears. Additionally, when the second light pattern appears, the obstacle recognition unit 210 may determine an obstacle in front or above.

The obstacle recognition unit 210 determines whether the main body 10 is tilted on the basis of tilt information input from the tilt sensor of the sensor unit 150, and when the main body 10 is tilted, compensates for tilting with respect to the position of the light pattern of the acquired image.

The travel control unit 230 controls the travel driving unit 250 to perform cleaning while traveling in a designated area of the cleaning area, and controls the cleaning unit 260 to perform cleaning by sucking in dust while traveling.

The travel control unit 230 determines whether the mobile robot can travel or enter in response to an obstacle recognized by the obstacle recognition unit 210, sets a traveling path such that the mobile robot travels approaching the obstacle, passes the obstacle, or avoids the obstacle, and controls the travel driving unit 250.

The map generation unit 220 generates a map of the cleaning area on the basis of information on obstacles determined by the obstacle recognition unit 210.

The map generation unit 220 generates a map of the cleaning area on the basis of obstacle information while traveling through the cleaning area during initial operation or when a map of the cleaning area is not stored. Additionally, the map generation unit 220 updates a previously generated map on the basis of obstacle information acquired during traveling.

The map generation unit 220 generates a basic map on the basis of information obtained from the obstacle recognition unit 210 during traveling, and generates a cleaning map by dividing the area from the basic map. In addition, the map generation unit 220 organizes areas for the cleaning map and sets attributes for the areas to create a user map and a guide map.

The basic map is a map in which the shape of a cleaning area obtained through traveling is displayed as an outline, and the cleaning map is a map in which the area of the basic map is divided. The basic map and the cleaning map include areas in which the mobile robot can travel and obstacle information. The user map is a map obtained by simplifying the areas of the cleaning map and organizing the shape of the outline and having visual effects added thereto. The guide map is a map in which the cleaning map and the user map overlap. Since the cleaning map is displayed on the guide map, a cleaning command can be input on the basis of areas where the mobile robot can actually travel.

After generating the basic map, the map generation unit 220 divides a cleaning area into a plurality of areas and generates a map including a connection passage connecting the plurality of areas and information on obstacles within each area. The map generation unit 220 separates small areas to set a representative area to distinguish areas on the map, sets separated small areas as a separate detailed area, and merges the same into the representative area to create a map with divided areas.

For each divided area, the map generation unit 220 processes the shape of the area. The map generation unit 220 sets attributes for a divided area and processes the shape of the area according to the attributes for each area.

The map generation unit 220 first determines a main area in each divided area on the basis of the number of contact points with other areas. The main area is basically a living room, but in some cases, the main area may be changed to one of a plurality of rooms. The map generation unit 220 sets attributes for the remaining areas on the basis of the main area. For example, the map generation unit 220 may set an area over a certain size disposed around the living room which is the main area as a room and set other areas as other areas.

In processing the shape of an area, the map generation unit 220 processes each area to have a specific shape according to criteria based on attributes of the area. For example, the map generation unit 220 processes the shape of an area on the basis of the shape of a typical room of a house, for example, a square. Additionally, the map generation unit 220 expands the shape of an area on the basis of the outermost cells of the basic map, and processes the shape of the area by deleting or reducing an area with respect to areas that are inaccessible due to obstacles.

In addition, in the basic map, the map generation unit 220 displays obstacles larger than a certain size on the map according to the sizes of obstacles, and deletes cells corresponding to obstacles smaller than the certain size such that the obstacles are not displayed. For example, the map generation unit displays furniture such as chairs and sofas larger than a certain size on the map, and deletes temporarily appearing obstacles and small obstacles such as small toys from the map. When creating a map, the map generation unit 220 also stores the position of the charging station on the map.

After the map is generated, the map generation unit 220 may add obstacles to the map on the basis of obstacle information input from the obstacle recognition unit 21 regarding detected obstacles. When a specific obstacle is repeatedly detected at a fixed position, the map generation unit 220 adds the obstacle to the map, and when an obstacle is temporarily detected, ignores the obstacle.

The map generation unit 220 generates both the user map, which is a processed map, and the guide map in which the user map and the cleaning map are displayed in an overlapping manner.

In addition, when a virtual wall is set, the map generation unit 220 sets the position of the virtual wall in the cleaning map on the basis of data regarding the virtual wall and calculates the coordinates of the virtual wall corresponding to a cleaning area. The map generation unit 220 registers the virtual wall as an obstacle in the cleaning map.

If the current position of the main body 10 cannot be determined by the position recognition unit 240, the map generation unit 220 generates a new map with respect to the cleaning area. The map generator 220 determines movement to a new area and initializes the preset virtual wall.

The mobile robot performs cleaning on the basis of the cleaning map, and transmits the user map and the guide map to a terminal. The terminal can store both the guide map and the user map, display the same on a screen, and output either one depending on settings. When a cleaning command based on the user map or the guide map is input from the terminal, the mobile robot 1 travels based on the cleaning map to clean a designated area.

The position recognition unit 240 determines the current position of the main body 10 on the basis of the map (cleaning map, guide map, or user map) stored in the data unit.

When a cleaning command is input, the position recognition unit 240 determines whether the position on the map matches the current position of the main body 10, and then recognizes the current position to restore the current position of the mobile robot 1 if the current position does not match the position on the map or if the current position cannot be ascertained. When the current position is restored, the travel control unit 230 controls the travel driving unit such that the mobile robot 1 moves to a designated area on the basis of the current position. The cleaning command may be input from a remote controller (not shown), the operation unit 160, or the terminal.

If the current position does not match the position on the map or the current position cannot be ascertained, the position recognition unit 240 may analyze the acquired image input from the image acquisition unit 140 to estimate the current position based on the map.

The position recognition unit 240 processes the acquired image obtained at each position while the map is being created by the map generation unit 220 and associates the same with the map to recognize the global position of the main body 10.

The position recognition unit 240 can estimate and recognize the current position of the main body 10 even when the position of the main body 10 abruptly changes by comparing the map with the acquired image for each position on the map using acquired images of the image acquisition unit 140 to ascertain the current position of the main body 10.

The position recognition unit 240 analyzes various features included in an acquired image, such as lights located on the ceiling, edges, corners, blobs, and ridges to determine the positions thereof. The acquired image may be input from the image acquisition unit or the second image acquisition unit provided at the upper part of the main body 10.

The position recognition unit 240 detects features from each acquired image. In the field of computer vision technology, various methods for detecting features from images (feature detection) are well known. Various feature detectors suitable for such feature detection are known. For example, there are Canny, Sobel, Harris&Stephens/Plessey, SUSAN, Shi&Tomasi, level curve curvature, FAST, Laplacian of Gaussian, difference of Gaussians, determinant of Hessian, MSER, PCBR, and grey-level blobs detectors, etc.

The position recognition unit 240 calculates a descriptor based on each feature point. The position recognition unit 240 may convert a feature point into a descriptor using scale invariant feature transform (SIFT) for feature detection. The descriptor can be represented as an n-dimensional vector. SIFT can detect features that are invariant to changes in scale, rotation, and brightness of a subject to be imaged, and thus can detect invariant (i.e., rotation-invariant) features even when the same area is imaged while changing the posture of the mobile robot 1. Of course, the present disclosure is not limited thereto and various other techniques (e.g., histogram of oriented gradient (HOG), Haar feature, Fems, local binary pattern (LBP), and modified census transform (MCT)) may be applied.

Based on descriptor information obtained through the acquired images of each position, the position recognition unit 240 may classify at least one descriptor for each acquired image into a plurality of groups according to a predetermined sub-classification rule, and convert descriptors belonging to the same group into sub-representation descriptors according to a predetermined sub-representative rule. As another example, all descriptors collected from acquired images within a predetermined area, such as a room, are classified into a plurality of groups according to the predetermined sub-classification rule, and descriptors included in the same group are converted into sub-representative descriptors according to the predetermined sub-representative rule.

The position recognition unit 240 can obtain the feature distribution of each position through this process. Each position feature distribution can be represented as a histogram or an n-dimensional vector. As another example, the position recognition unit 240 may estimate an unknown current position based on a descriptor calculated from each feature point without going through the predetermined sub-classification rule and the predetermined sub-representative rule.

In addition, in a case where the current position of the mobile robot 1 becomes unknown due to position jump or the like, the position recognition unit 240 can estimate the current position on the basis of data such as pre-stored descriptors or sub-representative descriptors.

The position recognition unit 240 acquires an image through the image acquisition unit 140 at an unknown current position, and detects features from the acquired image upon identifying various features such as lights located on the ceiling, edges, corners, and blobs through the image.

The position recognition unit 240 converts the features into information (sub-recognition feature distribution) that can be compared with position information to be compared according to a predetermined sub-conversion rule on the basis of at least one piece of recognition descriptor information obtained through the acquired image of the unknown current position. According to a predetermined sub-comparison rule, each position feature distribution can be compared with each recognition feature distribution to calculate each similarity. Similarity (probability) is calculated for each position, and the position with the highest probability can be determined as the current position.

When the map is updated by the map generation unit 220 during traveling, the control unit 200 transmits the updated information to the terminal through the communication unit such that the terminal and the mobile robot 1 store the same map. Accordingly, since the maps stored in the terminal and the mobile robot 1 remain the same, the mobile robot 1 can clean the designated area in response to a cleaning command from the terminal, and the terminal can indicate the current position of the mobile robot on the map.

When a cleaning command is input, the travel control unit 230 controls the travel driving unit to move to a designated area among cleaning areas and operates the cleaning unit such that cleaning is performed along with traveling.

When a cleaning command for a plurality of areas is input, the travel control unit 230 causes the mobile robot to move the areas to perform cleaning according to whether a priority area is set or in a designated order, and if a separate order is not designated, causes the mobile robot to move to a nearby or adjacent area based on the current position to perform cleaning.

Additionally, when a cleaning command for an arbitrary area is input regardless of area division, the travel control unit 230 causes the mobile robot to move to an area included in the arbitrary area and performs cleaning.

When a virtual wall is set, the travel control unit 230 controls the travel driving unit such that the mobile robot travels while avoiding the virtual wall on the basis of coordinate values input from the map generation unit 220.

Even if the obstacle recognition unit 210 determines that no obstacle exists, the travel control unit 230 recognizes that an obstacle is present at the corresponding position and restricts traveling when a virtual wall is set.

When cleaning of a designated area is completed, the control unit 200 stores the cleaning record in the data unit.

Additionally, the control unit 200 transmits the operating status or cleaning status of the mobile robot 1 to the terminal at a predetermined interval through the communication unit 190.

Based on the data received from the mobile robot 1, the terminal displays the position of the mobile robot along with a map on the screen of an application that is being executed and also outputs information on the cleaning status.

Depending on settings, the terminal displays either the user map or the guide map on the screen, and the display may be changed through settings.

The terminal may display a received map on the screen, change areas by separating or merging the areas through key input or touch input, and change or add attributes of an area. Additionally, the terminal may designate a position of a specific obstacle on the map, and information on the designated obstacle is transmitted to the mobile robot and added to the previously stored map.

The terminal may designate a cleaning area and set a cleaning order in response to key input or touch input on a displayed map, and transmit a cleaning command to the mobile robot.

Additionally, the terminal displays a cleaning status on the displayed map (user map and guide map) based on data received from the mobile robot. In a case where information on obstacles is added, the terminal updates and displays the map on the basis of received data.

Additionally, upon detecting the charging station through a return signal from the charging station, the control unit 200 recognizes the current position of the mobile robot, calculates the position of the charging station on the basis of the current position of the mobile robot and stores the same. The control unit 200 may be set to display the position of the charging station on the map.

As an example, the control unit 200 may include an obstacle determination unit 222, an area calculation unit 224, and a virtual wall registration unit 226.

Since there are low objects that are not detected by the obstacle detection unit 100, when the mobile robot only travels by analyzing an obstacle detection signal, the mobile robot does not recognize low objects as obstacles, resulting in deterioration of traveling performance and cleaning performance.

Therefore, the present disclosure analyzes low-height objects using an impact detection signal, registers virtual walls on a map, and prioritizes virtual wall positioning in consideration of a small number of impact detection sensors 152 and various variables.

When an impact detection signal is input while the main body 10 is traveling, the control unit 200 determines whether the impact detection signal is caused by an obstacle or an external object. If it is determined that the impact detection signal is not caused by an obstacle, the control unit 200 determines a virtual wall registrable area and registers a virtual wall according to registration priority within the virtual wall registerable area. In addition, the control unit 200 controls the main body 10 such that the main body 10 travels while avoiding the registered virtual wall.

Specifically, when an impact detection signal is input while the main body 10 is traveling, the obstacle determination unit 222 determines whether an external object which has collided with the main body 10 is an obstacle on the basis of an obstacle detection signal input from the sensor unit 150 or the obstacle detection unit 100.

When external impact (bumping) occurs, the obstacle determination unit 222 determines whether the external impact is an object that has not been detected by the obstacle detection unit 100.

When the obstacle determination unit 222 determines that the external object that has collided with the main body 10 is not an obstacle, the area calculation unit 224 determines a virtual wall registerable area including a plurality of cells on the basis of the position on the map at which the impact detection signal has been input.

The area calculation unit 224 may calculate the coordinates (X, Y) of the signal input cell on the map corresponding to the position at which the impact detection signal has been input, and determine the signal input cell and at least one neighboring cell adjacent to the signal input cell as a virtual wall registrable area.

Specifically, the area calculation unit 224 may determine the signal input cell and at least one neighboring cell adjacent to the signal input cell as a virtual wall registerable area in consideration of the size of the main body 10, the shape of the main body 10, and the installation position of the impact detection sensor 152.

More specifically, the area calculation unit 224 determines the virtual wall registerable area in consideration of information on the size of the main body 10, information on the shape of the main body 10, and information on the installation position of the impact detection sensor 152 stored in the data unit 280.

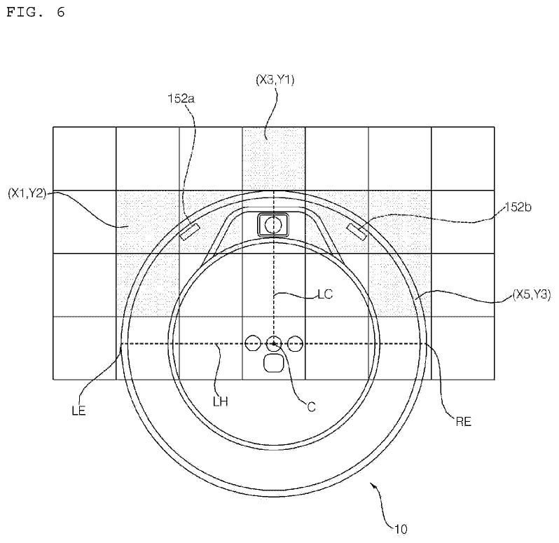

The area calculation unit 224 may calculate the coordinates of the signal input cell on the map corresponding to the position at which the impact detection signal has been input. The signal input cell coordinates are defined as cell coordinates that overlap with the impact detection sensor 152 provided in the main body 10 when the impact detection signal is input. Referring to FIG. 6, when one impact detection sensor is provided in front, the signal input cell coordinates are (X3, Y2).

After determining the signal input cell coordinates, the area calculation unit 224 determines the area overlapping with the border of the front area of the main body 10 in plan view as neighboring cells on the basis of the information on the size of the main body 10, the information on the shape of the main body 10, and information on movement of the main body 10. The area overlapping with the border of the front area of the main body 10 is cells that vertically overlap with an area located forward of the center of the main body 10 (forward of the center horizontal line LH) at the border of the main body 10 (colored cells in FIG. 6).

Of course, the area calculation unit 224 can determine certain cells adjacent to the signal input cell as neighboring cells.

As another example, when the impact detection sensor 152 includes the first impact detection sensor 152a located on the side of the main body 10 between the front end of the main body 10 and the left end of the main body 10 and the second impact detection sensor 152b located on the side of the main body 10 between the front end of the main body 10 and the right end of the main body 10, if impact detection signals are simultaneously input from the first impact detection sensor 152a and the second impact detection sensor 152b, the area calculation unit 224 may calculate coordinates of a first signal input cell and a second signal input cell on the map corresponding to the positions of the first impact detection sensor 152a and the second impact detection sensor 152b, and determine cells between the first signal input cell and the second signal input cell, the first signal input cell, and the second signal input cell as a virtual wall registerable area. Preferably, the cells between the first signal input cell and the second signal input cell may be cells (X3, Y1), (X1, Y2), (X2, Y2), (X3, Y1), (X4, Y2), (X5, Y2), and (X5, Y3) that overlap with the border of the front area of the main body 10.

Here, the front end FE of the main body 10 is defined as a point where the center vertical line LC and the front side of the main body 10 meet, the left end LE of the main body 10 means a point where the center horizontal line LH and the left side of the main body 10 meet, and the right end RE of the main body 10 means a point where the center horizontal line LH and the right side of the main body 10 meet.

In addition, when the impact detection sensor 152 includes the first impact detection sensor 152a and the second impact detection sensor 152b, if an impact detection signal is input from one of the first impact detection sensor 152a and the second impact detection sensor 152b, the area calculation unit 224 may calculate coordinates of a signal input cell on the map corresponding to the position of the impact detection sensor 152 from which the impact detection signal has been input, and determine at least one neighboring cell adjacent to the signal input cell and the signal input cell as a virtual wall registerable area in consideration of the size of the main body 10, the shape of the main body 10, and the installation position of the impact detection sensor 152.

When an impact detection signal is input from the first impact detection sensor 152a, as shown in FIG. 6, a virtual wall registerable area may include a signal input cell and cells (X3, Y1), (X1, Y2), (X2, Y2), and (X3, Y1) that overlap the border of the front left area of the main body 10 (90-degree azimuth area counterclockwise from the reference point) among cells adjacent to the signal input cell.

When an impact detection signal is input from the second impact detection sensor 152b, as shown in FIG. 6, a virtual wall registerable area may include a signal input cell and cells (X3, Y1), (X4, Y2), (X5, Y2), and (X5, Y3) that overlap the border of the front right area of the main body 10 (90-degree azimuth area clockwise from the reference point) among cells adjacent to the signal input cell.

The virtual wall registration unit 226 registers one of a plurality of cells within a virtual wall registerable area as a virtual wall on the map according to registration priority. The registration priority may be preset, may be a pre-stored table, or may be trained data.

The virtual wall registration unit 226 may determine a first priority cell from among the plurality of cells within the virtual wall registerable area according to the registration priority, and register the first priority cell as a virtual wall according to attributes of the first priority cell on the map. Attributes of a cell may include information on whether the cell is an obstacle, information on whether the cell is a virtual wall, and time information of the virtual wall.

Specifically, the virtual wall registration unit 226 may determine the first priority cell from among the plurality of cells within the virtual wall registerable area according to the registration priority, and if the attributes of the first priority cell in the map do not indicate a virtual wall, register the first priority cell as a virtual wall.

If the attributes of the first priority cell indicate a virtual wall, the virtual wall registration unit 226 may determine a second priority cell from among the plurality of cells within the virtual wall registerable area according to the registration priority, and register the second priority cell as a virtual wall depending on the attributes of the second priority cell. The virtual wall registration unit 226 may register the second priority cell as a virtual wall if the attributes of the second priority cell do not indicate a virtual wall, and determine a third priority cell if the attributes of the second priority cell indicate a virtual wall. Meanwhile, if all attributes of the first priority cell to the last priority cell indicate a virtual wall, the virtual wall is not registered, and the control unit 200 controls the main body 10 such that the main body 10 travels while avoiding a pre-registered virtual wall.

As another example, the virtual wall registration unit 226 determines an n-th priority cell from among the plurality of cells within the virtual wall registerable area according to the registration priority, and registers the n-th priority cell as a virtual wall according to attributes of the n-th priority cell in the map. In a case where the n-th priority cell cannot be registered as a virtual wall according to the attributes of the n-th priority cell, the virtual wall registration unit 226 determines an (n+1)-th priority cell from among the plurality of cells within the virtual wall registerable area according to the registration priority, and registers the (n+1)-th priority cell as a virtual wall according to attributes of the (n+1)-th priority cell.

The virtual wall registration unit 226 may determine the registration priority in descending order of a probability of not detecting impact in areas depending on a position at which the impact detection sensor is disposed. The probability of not detecting impact may be pre-stored and learned.

When one impact detection sensor is installed in front, the virtual wall registration unit 226 may set the first priority to cells (X1, Y3) and (X5, Y5) which overlap the left end or the right end at the border of the front area of the main body 10 among cells within a virtual wall registerable area. If there is a plurality of first-priority cells, the virtual wall registration unit 226 may randomly select one of the plurality of first-priority cells. The second priority corresponds to cell coordinates (X1, Y2) and (X5, Y2), the third priority corresponds to cell coordinates (X2, Y2) and (X4, Y2), and the fourth priority corresponds to cell coordinates (X4, Y1).

In addition, when the impact detection sensor 152 includes the first impact detection sensor 152a and the second impact detection sensor 152b, if an impact detection signal is input from one of the first impact detection sensor 152a and the second impact detection sensor 152b, the area calculation unit 224 determines a signal input cell and at least one neighboring cell adjacent to the signal input cell as a virtual wall registerable area, and the virtual wall registration unit 226 may set a higher registration priority to a cell farther from the center between the first impact detection sensor 152a and the second impact detection sensor 152b among the cells between the first signal input cell and the second signal input cell.

Specifically, when the impact detection sensor 152 includes the first impact detection sensor 152a and the second impact detection sensor 152b, if an impact detection signal is input from the first impact detection sensor 152a, a virtual wall registerable area (X3, Y1), (X1, Y2), (X2, Y2), and (X3, Y1) is determined, and the virtual wall registration unit 226 may set the first priority to the cell (X3, Y1) farthest from the center between the first impact detection sensor 152a and the second impact detection sensor 152b in the virtual wall registerable area (X3, Y1), (X1, Y2), (X2, Y2), and (X3, Y1). The second priority is set to the cell coordinates (X1, Y2), the third priority is set to the cell coordinates (X2, Y2), and the fourth priority is set to the cell coordinates (X4, Y1).

When the impact detection sensor 152 includes the first impact detection sensor 152a and the second impact detection sensor 152b, if an impact detection signal is input from the second impact detection sensor 152b, a virtual wall registerable area (X3, Y1), (X4, Y2), (X5, Y2), and (X5, Y3) are determined, and the virtual wall registration unit 226 may set the first priority to the cell (X5, Y3) farthest from the center between the first impact detection sensor 152a and the second impact detection sensor 152b in the virtual wall registerable area (X3, Y1), (X4, Y2), (X5, Y2), and (X5, Y3). The second priority is set to the cell coordinates (X5, Y2), the third priority is set to the cell coordinates (X4, Y2), and the fourth priority is set to the cell coordinates (X4, Y1).

Although the virtual wall registration priority may be determined by learning as described above, it is preferable to determine the order as described above. The reason is that when there are two impact detection sensors 152, it is easy to avoid a virtual wall and it is most advantageous for detecting objects that are not detected by the obstacle detection unit 100 when the impact detection sensors are disposed as shown in FIG. 6 and the virtual wall registration priority is set as described above.

When registering a virtual wall on a map, the virtual wall registration unit 226 may also register attribute information including at least one of time information, information on the number of times of cleaning, or cleaning area information. Here, the time information may include a virtual wall registration time, and the information on the number of times of cleaning may be the cumulative total of the number of times of cleaning the cleaning area when a virtual wall is registered.

Meanwhile, the control unit 200 may initialize virtual walls for which a certain period of time has elapsed among virtual walls registered in a map. The control unit 200 may retrieve time information among attribute information of virtual walls registered in the map and initialize virtual walls for which a certain period of time has elapsed among the virtual walls registered in the map. Here, initializing a virtual wall means deleting the virtual wall from the map.

The control unit 200 may initialize virtual walls for which a certain number of times of cleaning has passed among the virtual walls registered in the map. The control unit 200 may retrieve the number of times of cleaning among the attribute information of the virtual walls registered in the map and initialize virtual walls for which a certain number of times of cleaning among the virtual walls registered in the map. More specifically, the control unit 200 may remove, from the map, virtual walls for which there is a difference of a certain number of times of cleaning or more from the current number of times of cleaning among the virtual walls.

When the map is divided into a plurality of cleaning areas and cleaning is started, the control unit 200 may initialize a virtual wall located within at least one cleaning area randomly selected from the plurality of cleaning areas.

The control unit 200 divides the map into a plurality of cleaning areas at the start of cleaning, and may initialize a virtual wall within a cleaning area determined according to the number of times of cleaning when starting cleaning.

As another example, the control unit 200 may include the area calculation unit 224 and the virtual wall registration unit 226.

If the control unit 200 excludes the obstacle determination unit 222 and includes the area calculation unit 224 and the virtual wall registration unit 226, when an impact detection signal is received while the main body 10 is traveling, the control unit 200 may determine a virtual wall registerable area and register a virtual wall without determining whether the impact corresponding to the impact detection signal is an obstacle. Unless otherwise specified, descriptions of the area calculation unit 224 and the virtual wall registration unit 226 are the same as those described above.

Specifically, when an impact detection signal is input while the main body 10 is traveling, the area calculation unit 224 determines a virtual wall registerable area including a plurality of cells on the basis of the position on the map at which the impact detection signal has been input.

The virtual wall registration unit 226 may register one of the plurality of cells within the virtual wall registerable area as a virtual wall in the map according to registration priority.

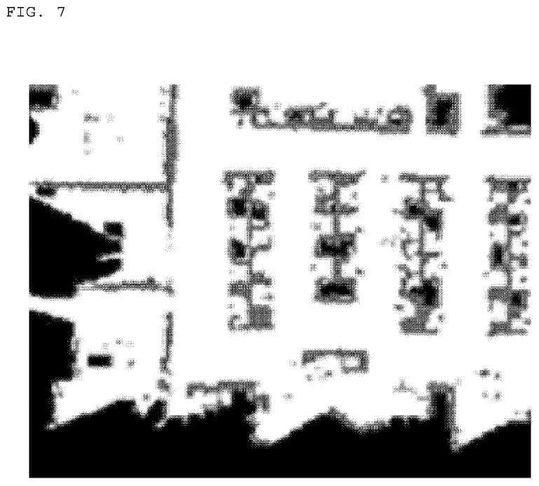

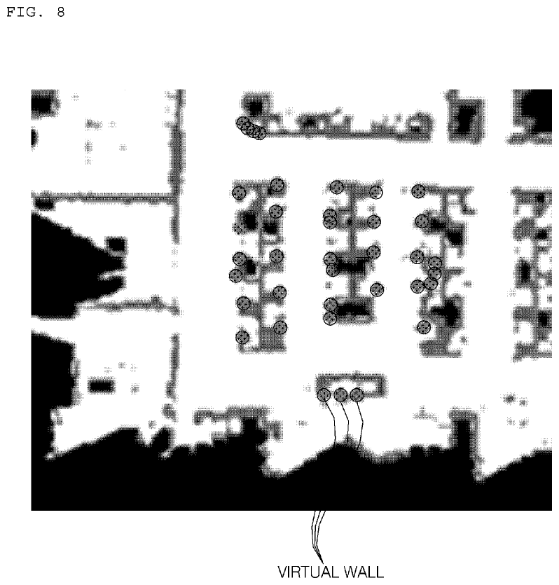

FIGS. 7 and 8 are diagrams referenced to describing a map generation method of the mobile robot according to an embodiment of the present disclosure.

As shown in FIG. 7, the mobile robot 1 can generate a map by traveling in a cleaning area through wall following or the like in a case where the map is not stored therein or during initial operation. Additionally, the mobile robot 1 may generate a map through obstacle information obtained while cleaning a cleaning area without a map.

The map generation unit 220 generates a map on the basis of data input from the obstacle detection unit 100 and the sensor unit 150 and obstacle information from the obstacle recognition unit 210 while the mobile robot 1 is traveling.

The map generation unit 220 generates a basic map including outlines of cleaning areas through wall following. Since the basic map includes outlines for the entire area, areas are not divided in the basic map.

Additionally, the map generation unit 220 may divide the basic map into a plurality of areas and generate a map with divided areas, a cleaning map.

As shown in FIG. 8, when an impact detection signal is detected, the control unit 200 determines whether the impact detection signal corresponds to an obstacle, and if not, determines a virtual wall registerable area and registers virtual walls in the map according to registration priority. The registered virtual walls include attribute information such as time information and information on the number of times of cleaning.

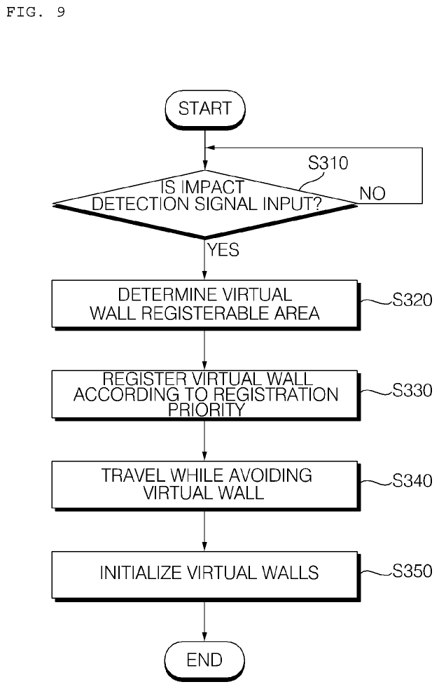

FIG. 9 is a flowchart showing a method of controlling the mobile robot according to an embodiment of the present disclosure.

Referring to FIG. 9, the method of controlling the mobile robot according to an embodiment of the present disclosure may include detecting an impact detection signal while the main body is traveling, estimating a virtual wall registerable area including a plurality of cells on the basis of a position on a map at which the impact detection signal has been input upon detecting the impact detection signal during the main body is traveling, and registering one of the plurality of cells within the virtual wall registerable area as a virtual wall in the map according to registration priority.

The control unit 200 starts traveling to a cleaning area.

The control unit 200 detects input of an impact detection signal through the impact detection sensor 152 while the main body 10 is traveling (S410).

Thereafter, when an impact detection signal is input while the main body 10 is traveling, the control unit 200 determines whether an external object colliding with the main body 10 is an obstacle on the basis of an obstacle detection signal input from the sensor unit 150 or the obstacle detection unit 100 (S420).

Upon determining that the external object colliding with the main body 10 is an obstacle, the control unit 200 controls the main body 10 such that the main body 10 travels while avoiding the obstacle (S470).

Upon determining that the external object colliding with the main body 10 is not an obstacle, the control unit 200 determines a virtual wall registerable area including a plurality of cells on the basis of the position on the map at which the impact detection signal has been input (S430). Of course, the control unit 200 may calculate coordinates (X, Y) of a signal input cell on the map corresponding to the position at which the impact detection signal has been input and determine the signal input cell and at least one neighboring cell adjacent to the signal input cell as a virtual wall registerable area. In addition, the control unit 200 may determine the signal input cell and at least one neighboring cell adjacent to the signal input as a virtual wall registerable area in consideration of the size of the main body 10, the shape of the main body 10, and the installation position of the impact detection sensor 152.

Meanwhile, when the impact detection sensor 152 includes the first impact detection sensor 152a and the second impact detection sensor 152b, the method of determining a virtual wall registerable area is as described above.

The control unit 200 registers one of the plurality of cells within the virtual wall registration area as a virtual wall in the map according to registration priority (S440). The registration priority may be preset, may be a pre-stored table, may be trained data, or may be the same as described above. The control unit 200 may also register attribute information of the virtual wall when registering the virtual wall.

The control unit 200 controls the main body 10 such that the main body 10 travels while avoiding the registered virtual wall (S450). Here, the control unit 200 controls the main body 10 such that the main body 10 travels while avoiding both the registered virtual wall and pre-registered virtual walls.

The control unit 200 may initialize at least some virtual walls registered in the map (S460). The control unit 200 may retrieve time information among attribute information of virtual walls registered in the map, and initialize virtual walls for which a certain period of time has elapsed among the virtual walls registered in the map. The control unit 200 may initialize virtual walls for which a certain number of times of cleaning has passed among the virtual walls registered in the map. When dividing the map into a plurality of cleaning areas and starting cleaning, the control unit 200 may initialize a virtual wall located within at least one cleaning area randomly selected from the plurality of cleaning areas. The control unit 200 divides the map into a plurality of cleaning areas at the start of cleaning and may initialize a virtual wall within a cleaning area determined according to the number of times of cleaning when starting cleaning.

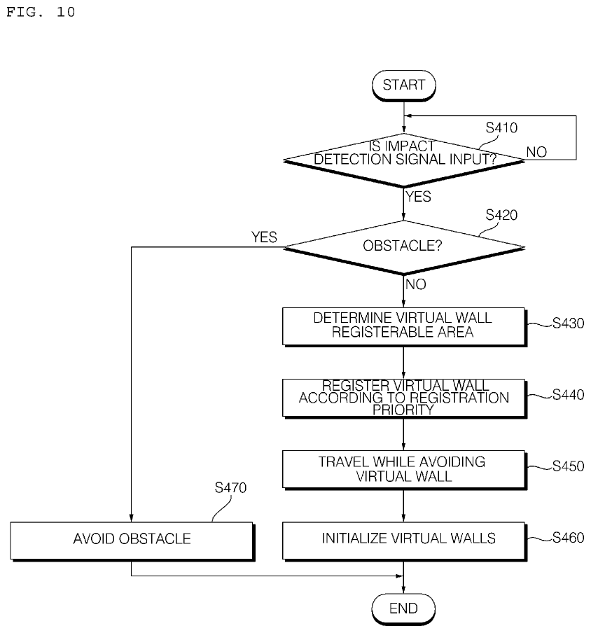

FIG. 10 is a flowchart showing a method of controlling the mobile robot according to another embodiment of the present disclosure.

Referring to FIG. 10, the control unit 200 starts traveling to a cleaning area.

The control unit 200 detects input of an impact detection signal through the impact detection sensor 152 while the main body 10 is traveling (S310).

Thereafter, when an impact detection signal is input while the main body 10 is traveling, the control unit 200 determines a virtual wall registerable area including a plurality of cells on the basis of the position on a map at which the impact detection signal has been input (S320). Of course, the control unit 200 may calculate coordinates (X, Y) of a signal input cell on the map corresponding to the position at which the impact detection signal has been input and determine the signal input cell and at least one neighboring cell adjacent to the signal input cell as a virtual wall registerable area. In addition, the control unit 200 may determine the signal input cell and at least one neighboring cell adjacent to the signal input as a virtual wall registerable area in consideration of the size of the main body 10, the shape of the main body 10, and the installation position of the impact detection sensor 152.

Meanwhile, when the impact detection sensor 152 includes the first impact detection sensor 152a and the second impact detection sensor 152b, the method of determining a virtual wall registerable area is as described above.

Thereafter, the control unit 200 registers one of the plurality of cells within the virtual wall registration area as a virtual wall in the map according to registration priority (S330). The registration priority may be preset, may be a pre-stored table, may be trained data, or may be the same as described above. The control unit 200 may also register attribute information of the virtual wall when registering the virtual wall.

The control unit 200 controls the main body 10 such that the main body 10 travels while avoiding the registered virtual wall (S340). Here, the control unit 200 controls the main body 10 such that the main body 10 travels while avoiding both the registered virtual wall and pre-registered virtual walls.

The control unit 200 may initialize at least some virtual walls registered in the map (S350). The control unit 200 may retrieve time information among attribute information of virtual walls registered in the map, and initialize virtual walls for which a certain period of time has elapsed among the virtual walls registered in the map. The control unit 200 may initialize virtual walls for which a certain number of times of cleaning has passed among the virtual walls registered in the map. When dividing the map into a plurality of cleaning areas and starting cleaning, the control unit 200 may initialize a virtual wall located within at least one cleaning area randomly selected from the plurality of cleaning areas. The control unit 200 divides the map into a plurality of cleaning areas at the start of cleaning and may initialize a virtual wall within a cleaning area determined according to the number of times of cleaning when starting cleaning.

Although preferred embodiments of the present disclosure have been illustrated and described above, the present disclosure is not limited to the specific embodiments described above and various modifications can be made by those skilled in the art without departing from the gist of the present disclosure as claimed in the claims. Such modifications should not be understood individually from the technical idea or perspective of the present disclosure.

1. A mobile robot comprising:
a main body;
a travel driving unit provided in the main body and configured to move the main body;
a data unit in which a map of cleaning areas is stored;
an impact detection sensor disposed in the main body and configured to detect impact between the main body and an external object and to generate an impact detection signal; and
a control unit configured to generate the map including information on the cleaning areas,
wherein the control unit is configured to:
determine a virtual wall registerable area including a plurality of cells on the basis of a position on the map at which the impact detection signal is input when the impact detection signal is input; and
register one of the plurality of cells within the virtual wall registerable area as a virtual wall in the map according to registration priority.

2. The mobile robot according to claim 1, wherein an area calculation unit calculates coordinates of a signal input cell on the map corresponding to the position at which the impact detection signal is input and determines the signal input cell and at least one neighboring cell adjacent to the signal input cell as the virtual wall registerable area.

3. The mobile robot according to claim 1, wherein the control unit calculates coordinates of a signal input cell on the map corresponding to the position at which the impact detection signal is input and determines the signal input cell and at least one neighboring cell adjacent to the signal input cell as the virtual wall registerable area in consideration of a size of the main body, a shape of the main body, and an installation position of the impact detection sensor.

4. The mobile robot according to claim 1, wherein the control unit determines a first priority cell from among the plurality of cells within the virtual wall registerable area according to the registration priority and registers the first priority cell as a virtual wall in the map according to attributes of the first priority cell.

5. The mobile robot according to claim 1, wherein the control unit determines a first priority cell from among the plurality of cells within the virtual wall registerable area according to the registration priority and registers the first priority cell as a virtual wall if attributes of the first priority cell in the map do not indicate a virtual wall.

6. A mobile robot comprising:
a main body;
a travel driving unit provided in the main body and configured to move the main body;
a data unit in which a map of cleaning areas is stored;
an obstacle detection unit configured to detect an obstacle in front of the main body and to input an obstacle detection signal;
an impact detection sensor disposed in the main body and configured to detect impact between the main body and an external object and to generate an impact detection signal; and
a control unit configured to determine an obstacle in response to an obstacle detection signal input from the obstacle detection unit and to generate the map including information on an area where the main body is capable of traveling among the cleaning areas on the basis of information on the obstacle,
wherein the control unit comprises:
an obstacle determination unit configured to determine whether an external object colliding with the main body is an obstacle on the basis of the obstacle detection signal when the impact detection signal is input;
an area calculation unit configured to determine a virtual wall registerable area including a plurality of cells on the basis of a position on the map at which the impact detection signal is input if the obstacle determination unit determines that the external object colliding with the main body is not an obstacle; and
a virtual wall registration unit configured to register one of the plurality of cells within the virtual wall registerable area as a virtual wall in the map according to registration priority.

7. The mobile robot according to claim 6, wherein the area calculation unit calculates coordinates of a signal input cell on the map corresponding to the position at which the impact detection signal is input, and determines the signal input cell and at least one neighboring cell adjacent to the signal input cell as the virtual wall registerable area.

8. The mobile robot according to claim 6, the area calculation unit calculates coordinates of a signal input cell on the map corresponding to the position at which the impact detection signal is input, and determines the signal input cell and at least one neighboring cell adjacent to the signal input cell as the virtual wall registerable area in consideration of a size of the main body, a shape of the main body, and an installation position of the impact detection sensor.

9. The mobile robot according to claim 6, wherein the virtual wall registration unit determines a first priority cell from among the plurality of cells within the virtual wall registerable area according to the registration priority, and registers the first priority cell as a virtual wall according to attributes of the first priority cell in the map.

10. The mobile robot according to claim 6, wherein the virtual wall registration unit determines a first priority cell from among the plurality of cells within the virtual wall registerable area according to the registration priority, and if the attributes of the first priority cell in the map do not indicate a virtual wall, registers the first priority cell as a virtual wall.

11. The mobile robot according to claim 10, wherein the virtual wall registration unit determines a second priority cell from among the plurality of cells within the virtual wall registerable area according to the registration priority if the attributes of the first priority cell indicate a virtual wall, and registers the second priority cell as a virtual wall according to attributes of the second priority cell.

12. The mobile robot according to claim 6, wherein the virtual wall registration unit determines an n-th priority cell from among the plurality of cells within the virtual wall registerable area according to the registration priority, registers the n-th priority cell as a virtual wall according to attributes of the n-th priority cell in the map, determines an (n+1)-th priority cell from among the plurality of cells within the virtual wall registerable area according to the registration priority if the n-th priority cell is not able to be registered as a virtual wall according to the attributes of the n-th priority cell, and registers the (n+1)-th priority cell as a virtual wall according to attributes of the (n+1)-th priority cell in the map.

13. The mobile robot according to claim 6, wherein the virtual wall registration unit determines the registration priority in descending order of a probability of not detecting impact in areas depending on a position at which the impact detection sensor is disposed.

14. The mobile robot according to claim 6, wherein the impact detection sensor comprises:
a first impact detection sensor located on the side of the main body between a front end of the main body and a left end of the main body; and
a second impact detection sensor located on the side of the main body between the front end of the main body and a right end of the main body.

15. The mobile robot according to claim 14, wherein, if impact detection signals are simultaneously input from the first impact detection sensor and the second impact detection sensor, the area calculation unit calculates coordinates of a first signal input cell and a second signal input cell on the map corresponding to positions of the first impact detection sensor and the second impact detection sensor, and determines cells between the first signal input cell and the second signal input cell, the first signal input cell, and the second signal input cell as the virtual wall registerable area.

16. The mobile robot according to claim 15, wherein the virtual wall registration unit sets a higher registration priority to a cell farther from a center between the first impact detection sensor and the second impact detection sensor among the cells between the first signal input cell and the second signal input cell.

17. The mobile robot according to claim 14, wherein, if an impact detection signal is input from one of the first impact detection sensor and the second impact detection sensor, the area calculation unit calculates coordinates of a signal input cell on the map corresponding to a position at which the impact detection signal is input, and determines the signal input cell and at least one neighboring cell adjacent to the signal input cell as the virtual wall registerable area in consideration of the size of the main body, the shape of the main body, and the installation position of the impact detection sensor.

18. The mobile robot according to claim 17, wherein the virtual wall registration unit sets a higher registration priority to a cell farther from the center between the first impact detection sensor and the second impact detection sensor among the cells in the virtual wall registerable area.

19. The mobile robot according to claim 6, wherein the control unit controls the travel driving unit to travel while avoiding a virtual wall registered in the map.

20. The mobile robot according to claim 6, wherein the virtual wall registration unit registers attribute information including time information or information on the number of times of cleaning at the time of registering a virtual wall in the map.

21. The mobile robot according to claim 6, wherein the control unit initializes virtual walls for which a certain period of time has elapsed among virtual walls registered in the map.

22. The mobile robot according to claim 6, wherein the control unit initializes virtual walls for which a certain number of times of cleaning has passed among the virtual walls registered in the map.

23. The mobile robot according to claim 6, wherein the control unit divides the map into a plurality of cleaning areas and, at the time of starting cleaning, initializes a virtual wall located within at least one cleaning area randomly selected from among the plurality of cleaning areas.

24. The mobile robot according to claim 6, wherein the control unit divides the map into a plurality of cleaning areas at the start of cleaning, and initializes a virtual wall within a cleaning area determined according to the number of times of cleaning when starting cleaning.

25. A method of controlling a mobile robot, comprising:
detecting an impact detection signal while a main body is traveling;
if the impact detection signal is detected while the main body is traveling, determining a virtual wall registerable area including a plurality of cells on the basis of a position on a map at which the impact detection signal is input; and
registering one of the plurality of cells within the virtual wall registerable area as a virtual wall in a map according to registration priority.
